(19) United States
(12) Patent Application Publication
(10) Pub. No.: US 2003/0097557 A1
(43) Pub. Date: May 22, 2003

(54) Method, node and computer readable medium for performing multiple signature matching in an intrusion prevention system

(76) Inventors: Richard Paul Tarquini, Apex, NC (US); Richard Louis Schertz, Raleigh, NC (US); George Simon Gales, Plano, TX (US)

Correspondence Address: HEW LETT-PACKARD COMPANY, Intellectual Property Administration, P.O. Box 272400, Fort Collins, CO, 80527-2400, US

(21) Appl. No.: 10/003,819

(22) Filed: Oct. 31, 2001

(51) Int. Cl. G06F 11/30

(52) U.S. Cl. 713/153; 713/200

(57) ABSTRACT

A node of a network maintaining an instance of an intrusion prevention system, the node comprising a memory module for storing data in machine-readable format for retrieval and execution by a central processing unit and an operating system comprising a network stack comprising a protocol driver, a media access control driver and an instance of the intrusion prevention system implemented as an intermediate driver and bound to the protocol driver and the media access control driver, the intrusion prevention system comprising an associative process engine and an input/output control layer, the input/output control layer operable to receive at least one of a plurality of machine-readable network-exploit signatures from a database and provide the at least one machine-readable network-exploit signatures to the associative process engine, the associative process engine operable to compare a packet with the at least one machine-readable network-exploit signature and determine a correspondence between the packet and the at least one machine-readable network-exploit signature is provided. A method of analyzing a packet at a node of a network by an intrusion prevention system executed by the node comprising reading the packet by the intrusion prevention system, comparing the packet with a plurality of machine-readable network-exploit signatures, and determining a correspondence between the packet and at least two of the plurality of machine-readable network-exploit signatures is provided. A computer-readable medium having stored thereon a set of instructions to be executed, the set of instructions, when executed by a processor, cause the processor to perform a computer method of comparing a packet with a plurality of machine-readable network-exploit signatures, determining a correspondence between the packet and at least a subset of the plurality of machine-readable network-exploit signatures, and generating a record with which the correspondence is made.

### CROSS-REFERENCE TO RELATED APPLICATIONS

This patent application is related to co-pending U.S. patent application Ser. No. ______, entitled “METHOD AND COMPUTER READABLE MEDIUM FOR SUPPRESSING EXECUTION OF SIGNATURE FILE DIRECTIVES DURING A NETWORK EXPLOIT,” filed Oct. 31, 2001, co-assigned herewith; U.S. patent application Ser. No. ______, entitled “SYSTEM AND METHOD OF DEFINING THE SECURITY CONDITION OF A COMPUTER SYSTEM,” filed Oct. 31, 2001, co-assigned herewith; U.S. patent application Ser. No. ______, entitled “SYSTEM AND METHOD OF DEFINING THE SECURITY VULNERABILITIES OF A COMPUTER SYSTEM,” filed Oct. 31, 2001, co-assigned herewith; U.S. patent application Ser. No. ______, entitled “SYSTEM AND METHOD OF DEFINING UNAUTHORIZED INTRUSIONS ON A COMPUTER SYSTEM,” filed Oct. 31, 2001, co-assigned herewith; U.S. patent application Ser. No. ______, entitled “NETWORK INTRUSION DETECTION SYSTEM AND METHOD,” filed Oct. 31, 2001, co-assigned herewith; U.S. patent application Ser. No. ______, entitled “NODE, METHOD AND COMPUTER READABLE MEDIUM FOR INSERTING AN INTRUSION PREVENTION SYSTEM INTO A NETWORK STACK,” filed Oct. 31, 2001, co-assigned herewith; U.S. patent application Ser. No. ______, entitled “METHOD, COMPUTER-READABLE MEDIUM, AND NODE FOR DETECTING EXPLOITS BASED ON AN INBOUND SIGNATURE OF THE EXPLOIT AND AN OUTBOUND SIGNATURE IN RESPONSE THERETO,” filed Oct. 31, 2001, co-assigned herewith; U.S. patent application Ser. No. ______, entitled “NETWORK, METHOD AND COMPUTER READABLE MEDIUM FOR DISTRIBUTED SECURITY UPDATES TO SELECT NODES ON A NETWORK,” filed Oct. 31, 2001, co-assigned herewith; U.S. patent application Ser. No. ______, entitled “METHOD, COMPUTER READABLE MEDIUM, AND NODE FOR A THREE-LAYERED INTRUSION PREVENTION SYSTEM FOR DETECTING NETWORK EXPLOITS,” filed Oct. 31, 2001, co-assigned herewith; U.S. patent application Ser. No. ______, entitled “SYSTEM AND METHOD OF AN OS-INTEGRATED INTRUSION DETECTION AND ANTI-VIRUS SYSTEM,” filed Oct. 31, 2001, co-assigned herewith; U.S. patent application Ser. No. ______, entitled “METHOD, NODE AND COMPUTER READABLE MEDIUM FOR IDENTIFYING DATA IN A NETWORK EXPLOIT,” filed Oct. 31, 2001, co-assigned herewith; U.S. patent application Ser. No. ______, entitled “NODE, METHOD AND COMPUTER READABLE MEDIUM FOR OPTIMIZING PERFORMANCE OF SIGNATURE RULE MATCHING IN A NETWORK,” filed Oct. 31, 2001, co-assigned herewith; U.S. patent application Ser. No. ______, entitled “USER INTERFACE FOR PRESENTING DATA FOR AN INTRUSION PROTECTION SYSTEM,” filed Oct. 31, 2001, co-assigned herewith; U.S. patent application Ser. No. ______, entitled “NODE AND MOBILE DEVICE FOR A MOBILE TELECOMMUNICATIONS NETWORK PROVIDING INTRUSION DETECTION,” filed Oct. 31, 2001, co-assigned herewith; U.S. patent application Ser. No. ______, entitled “METHOD AND COMPUTER-READABLE MEDIUM FOR INTEGRATING A DECODE ENGINE WITH AN INTRUSION DETECTION SYSTEM,” filed Oct. 31, 2001, co-assigned herewith; U.S. patent application Ser. No. ______, entitled “SYSTEM AND METHOD OF GRAPHICALLY DISPLAYING DATA FOR AN INTRUSION PROTECTION SYSTEM,” filed Oct. 31, 2001, co-assigned herewith; and U.S. patent application Ser. No. ______, entitled “SYSTEM AND METHOD OF GRAPHICALLY CORRELATING DATA FOR AN INTRUSION PROTECTION SYSTEM,” filed Oct. 31, 2001, co-assigned herewith.

### TECHNICAL FIELD OF THE INVENTION

This invention relates to network technologies and, more particularly, to a method, node and computer readable medium for performing multiple signature matching in an intrusion prevention system.

### BACKGROUND OF THE INVENTION

Network-exploit attack tools, such as denial-of-service (DoS) attack utilities, are becoming increasing sophisticated and, due to evolving technologies, simple to execute. Relatively unsophisticated attackers can arrange, or be involved in, computer system compromises directed at one or more targeted facilities. A network system attack (also referred to herein as an intrusion) is an unauthorized or malicious use of a computer or computer network and may involve hundred or thousands of unprotected, or alternatively compromised, Internet nodes together in a coordinated attack on one or more selected targets.

Network attack tools based on the client/server model have become a preferred mechanism for executing network attacks on targeted networks or devices. High capacity machines in networks having deficient security are often desired by attackers to launch distributed attacks therefrom. University servers typically feature high connectivity and capacity but relatively mediocre security. Such networks also often have inexperienced or overworked network administrators making them even more vulnerable for involvement in network attacks.

Network-exploit attack tools, comprising hostile attack applications such as denial-of-service utilities, responsible for transmitting data across a network medium will often have a distinctive “signature,” or recognizable pattern within the transmitted data. The signature may comprise a recognizable sequence of particular packets and/or recognizable data that is contained within one or more packets. Signature analysis is often performed by a network intrusion prevention system (IPS) and may be implemented as a pattern-matching algorithm and may comprise other signature recognition capabilities as well as higher-level application monitoring utilities. A simple signature analysis algorithm may search for a particular string that has been identified as associated with a hostile application. Once the string is identified within a network data stream, the one or more packets carrying the string may be identified as “hostile,” or exploitative, and the IPS may then perform any one or more of a number of actions, such as logging the identification of the frame, performing a countermeasure, or performing another data archiving or protection measure.

Intrusion prevention systems (IPS) encompass technology that attempts to identify exploits against a computer system or network of computer systems. Numerous types of IPSs exist and each are generally classified as either a network-based, host-based, or node-based IPS.

Network-based IPS appliances are typically dedicated systems placed at strategic places on a network to examine data packets to determine if they coincide with known attack signatures. To compare packets with known attack signatures, network-based IPS appliances utilize a mechanism referred to as passive protocol analysis to inconspicuously monitor, or “sniff,” all traffic on a network and to detect low-level events that may be discerned from raw network traffic. Network exploits may be detected by identifying patterns or other observable characteristics of network frames. Network-based IPS appliances examine the contents of data packets by parsing network frames and packets and analyzing individual packets based on the protocols used on the network. A network-based IPS appliance inconspicuously monitors network traffic inconspicuously, i.e., other network nodes may be, and often are, unaware of the presence of the network-based IPS appliance. Passive monitoring is normally performed by a network-based IPS appliance by implementation of a “promiscuous mode” access of a network interface device. A network interface device operating in promiscuous mode copies packets directly from the network media, such as a coaxial cable, 100baseT or other transmission medium, regardless of the destination node to which the packet is addressed. Accordingly, there is no simple method for transmitting data across the network transmission medium without the network-based IPS appliance examining it and thus the network-based IPS appliance may capture and analyze all network traffic to which it is exposed. Upon identification of a suspicious packet, i.e., a packet that has attributes corresponding to a known attack signature monitored for occurrence by the network-based IPS appliance, an alert may be generated thereby and transmitted to a management module of the IPS so that a networking expert may implement security measures. Network-based IPS appliances have the additional advantage of operating in real-time and thus can detect an attack as it is occurring. Moreover, a network-based IPS appliance is ideal for implementation of a state-based IPS security measure that requires accumulation and storage of identified suspicious packets of attacks that may not be identified “atomically,” that is by a single network packet. For example, transmission control protocol (TCP) synchronization (SYN) flood attacks are not identifiable by a single TCP SYN packet but rather are generally identified by accumulating a count of TCP SYN packets that exceed a predefined threshold over a defined period of time. A network-based IPS appliance is therefore an ideal platform for implementing state-based signature detection because the network-based IPS appliance may collect all such TCP SYN packets that pass over the local network media and thus may properly archive and analyze the frequency of such events.

However, network-based EPS appliances may often generate a large number of “false positives,” i.e., incorrect diagnoses of an attack. False positive diagnoses by network-based IPS appliances result, in part, due to errors generated during passive analysis of all the network traffic captured by the IPS that may be encrypted and formatted in any number of network supported protocols. Content scanning by a network-based IPS is not possible on an encrypted link although signature analysis based on protocol headers may be performed regardless of whether the link is encrypted or not. Additionally, network-based IPS appliances are often ineffective in high speed networks. As high speed networks become more commonplace, software-based network-based IPS appliances that attempt to sniff all packets on a link will become less reliable. Most critically, network-based IPS appliances can not prevent attacks unless integrated with, and operated in conjunction with, a firewall protection system.

Host-based IPSs detect intrusions by monitoring application layer data. Host-based IPSs employ intelligent agents to continuously review computer audit logs for suspicious activity and compare each change in the logs to a library of attack signatures or user profiles. Host-based IPSs may also poll key system files and executable files for unexpected changes. Host-based IPSs are referred to as such because the IPS utilities reside on the system to which they are assigned to protect. Host-based IPSs typically employ application-level monitoring techniques that examine application logs maintained by various applications. For example, a host-based IPS may monitor a database engine that logs failed access attempts and/or modifications to system configurations. Alerts may be provided to a management node upon identification of events read from the database log that have been identified as suspicious. Host-based IPSs, in general, generate very few false-positives. However, host-based IPS such as log-watchers are generally limited to identifying intrusions that have already taken place and are also limited to events occurring on the single host. Because log-watchers rely on monitoring of application logs, any damage resulting from the logged attack will generally have taken place by the time the attack has been identified by the IPS. Some host-based IPSs may perform intrusion-preventative functions such as ‘hooking’ or ‘intercepting’ operating system application programming interfaces to facilitate execution of preventative operations by an IPS based on application layer activity that appears to be intrusion-related. Because an intrusion detected in this manner has already bypassed any lower level IPS, a host-based IPS represents a last layer of defense against network exploits. However, host-based IPSs are of little use for detecting low-level network events such as protocol events.

Node-based IPSs apply the intrusion detection and/or prevention technology on the system being protected. An example of node-based IPS technologies is inline intrusion detection. A node-based IPS may be implemented at each node of the network that is desired to be protected. Inline IPSs comprise intrusion detection technologies embedded in the protocol stack of the protected network node. Because the inline IPS is embedded within the protocol stack, both inbound and outbound data will pass through, and be subject to monitoring by, the inline IPS. An inline IPS overcomes many of the inherent weaknesses of network-based solutions. As mentioned hereinabove, network-based solutions are generally ineffective when monitoring high-speed networks due to the fact that network-based solutions attempt to monitor all network traffic on a given link. Inline intrusion prevention systems, however, only monitor traffic directed to the node on which the inline IPS is installed. Thus, attack packets can not physically bypass an inline IPS on a targeted machine because the packet must pass through the protocol stack of the targeted device. Any bypassing of an inline IPS by an attack packet must be done entirely by ‘logically’ bypassing the IPS, i.e., an attack packet that evades an inline IPS must do so in a manner that causes the inline IPS to fail to identify, or improperly identify, the attack packet. Additionally, inline IPSs provide the hosting node with low-level monitoring and detection capabilities similar to that of a network IPS and may provide protocol analysis and signature matching or other low-level monitoring or filtering of host traffic. The most significant advantage offered by inline IPS technologies is that attacks are detected as they occur. Whereas host-based IPSs determine attacks by monitoring system logs, inline intrusion detection involves monitoring network traffic and isolating those packets that are determined to be part of an attack against the hosting server and thus enabling the inline IPS to actually prevent the attack from succeeding. When a packet is determine to be part of an attack, the inline IPS layer may discard the packet thus preventing the packet from reaching the upper layer of the protocol stack where damage may be caused by the attack packet—an effect that essentially creates a local firewall for the server hosting the inline IPS and protecting it from threats coming either from an external network, such as the Internet, or from within the network. Furthermore, the inline IPS layer may be embedded within the protocol stack at a layer where packets have been unencrypted so that the inline IPS is effective operating on a network with encrypted links. Additionally, inline IPSs can monitor outgoing traffic because both inbound and outbound traffic respectively destined to and originating from a server hosting the inline IPS must pass through the protocol stack.

Although the advantages of inline IPS technologies are numerous, there are drawbacks to implementing such a system. Inline intrusion detection is generally processor intensive and may adversely effect the node's performance hosting the detection utility. Additionally, inline IPSs may generate numerous false positive attack diagnoses. Furthermore, inline IPSs cannot detect systematic probing of a network, such as performed by reconnaissance attack utilities, because only traffic at the local server hosting the inline IPS is monitored thereby.

Each of network-based, host-based and inline-based IPS technologies have respective advantages as described above. Ideally, an intrusion prevention system will incorporate all of the aforementioned intrusion detection strategies. Additionally, an IPS may comprise one or more event generation mechanisms that report identifiable events to one or more management facilities. An event may comprise an identifiable series of system or network conditions or it may comprise a single identified condition. An IPS may also comprise an analysis mechanism or module and may analyze events generated by the one or more event generation mechanisms. A storage module may be comprised within an IPS for storing data associated with intrusion-related events. A countermeasure mechanism may also be comprised within the IPS for executing an action intended to thwart, or negate, a detected exploit.

In general, a given node in a network implementing an IPS will scan received network frames or packets for a correspondence of a respective signature scanned with a plurality of known attack signatures managed in a database or another storage facility. Prior art techniques may abort scanning for signatures upon a positive identification of a single attack signature. Processing directives associated with the identified signature may then be executed. For example, a signature may have a processing directive associated therewith that specifies that the frame, or packet, is to be logged into an archive and/or the directive may specify that processing of the frame, or packet, is to be dropped. Other directives are possible and may include executing a firewall rule, execution of one or more countermeasures, and/or execution of some other security measure.

Such signature processing exposes the IPS to a vulnerability, however. An attacker may gain information regarding the particular IPS implemented on a targeted network. An IPS may then be circumvented by an attacker by exploiting signature precedence for the purpose of implementing an attack that is not identified by the IPS due to the fact that signature processing is completed on the frame, or packet, upon an initial positive identification of a signature match. Similar prior art optimization techniques may employ a scheme where a signature match has a priority assigned thereto. A decision may then be made by the IPS as to which directive to execute based upon the priority of the signature match. Only a directive assigned to a single signature is executed in either manner and thus exposes the IPS to circumvention by a skilled attacker. Furthermore, sophisticated attack utilities may be designed to exploit such precedence and/or priority processing implemented by an IPS thus enabling less skilled attackers to exploit such vulnerabilities. While halting signature processing upon a first positive identification of an exploitative packet relieves the processing burden required at a network node, identification of a signature thereby only indicates a correspondence between a packet and one of a possible plurality of corresponding attack signatures.

### SUMMARY OF THE INVENTION

In accordance with an embodiment of the present invention, a node of a network maintaining an instance of an intrusion prevention system, the node comprising a memory module for storing data in machine-readable format for retrieval and execution by a central processing unit and an operating system comprising a network stack comprising a protocol driver, a media access control driver and an instance of the intrusion prevention system implemented as an intermediate driver and bound to the protocol driver and the media access control driver, the intrusion prevention system comprising an associative process engine and an input/output control layer, the input/output control layer operable to receive at least one of a plurality of machine-readable network-exploit signatures from a database and provide the at least one machine-readable network-exploit signatures to the associative process engine, the associative process engine operable to compare a packet with the at least one machine-readable network-exploit signature and determine a correspondence between the packet and the at least one machine-readable network-exploit signature is provided.

In accordance with another embodiment of the present invention, a method of analyzing a packet at a node of a network by an intrusion prevention system executed by the node comprising reading the packet by the intrusion prevention system, comparing the packet with a plurality of machine-readable network-exploit signatures, and determining a correspondence between the packet and at least two of the plurality of machine-readable network-exploit signatures is provided.

In accordance with another embodiment of the present invention, a computer-readable medium having stored thereon a set of instructions to be executed, the set of instructions, when executed by a processor, cause the processor to perform a computer method of comparing a packet with a plurality of machine-readable network-exploit signatures, determining a correspondence between the packet and at least a subset of the plurality of machine-readable network-exploit signatures, and generating a record with which the correspondence is made.

### BRIEF DESCRIPTION OF THE DRAWINGS

For a more complete understanding of the present invention, the objects and advantages thereof, reference is now made to the following descriptions taken in connection with the accompanying drawings in which:

FIG. 1 illustrates an exemplary arrangement for executing a computer system compromise according to the prior art;

FIG. 2 illustrates a comprehensive intrusion prevention system employing network-based and hybrid host-based and node based intrusion detection technologies according to an embodiment of the invention;

FIG. 3 is an exemplary network protocol stack according to the prior art;

FIG. 4 illustrates a network node that may run an instance of an intrusion protection system application according to an embodiment of the present invention;

FIG. 5 illustrates an exemplary network node that may operate as a management node within a network protected by the intrusion protection system according to an embodiment of the present invention;

FIG. 6 is a flowchart of IPS application processing according to an embodiment of the present invention;.

FIG. 7 is a flowchart of an IPS application processing procedure that may be performed by an associative process engine that provides reporting of multiple signature matches according to an embodiment of the invention; and

FIG. 8 is a flowchart of IPS processing performed at the application layer in response to IPS processing procedures described with reference to FIGS. 6 and 7 according to an embodiment of the present invention.

### DETAILED DESCRIPTION OF THE DRAWINGS

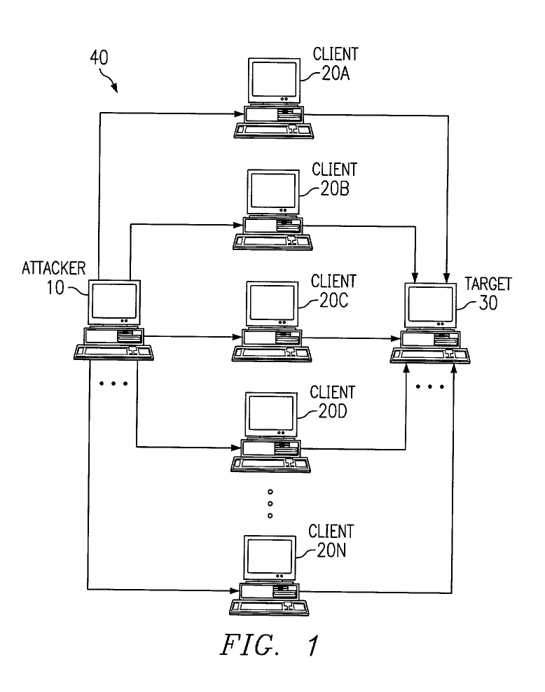

The preferred embodiment of the present invention and its advantages are best understood by referring to FIGS. 1 through 8 of the drawings, like numerals being used for like and corresponding parts of the various drawings.

In FIG. 1, there is illustrated an exemplary arrangement for executing a computer system compromise—the illustrated example showing a simplified distributed intrusion network 40 arrangement typical of distributed system attacks directed at a target machine 30. An attack machine 10 may direct execution of a distributed attack by any number of attack agents 20A-20N by one of numerous techniques such as remote control by IRC “robot” applications. Attack agents 20A-20N, also referred to as “zombies” and “attack agents,” are generally computers that are available for public use or that have been compromised such that a distributed attack may be launched upon command of an attack machine 10. Numerous types of distributed attacks may be launched against a target machine 30. The target machine 30 may suffer extensive damage from simultaneous attack by attack agents 20A-20N and the attack agents 20A-20N may be damaged from the client attack application as well. A distributed intrusion network may comprise an additional layer of machines involved in an attack intermediate the attack machine 10 and attack agents 20A-20N. These intermediate machines are commonly referred to as “handlers” and each handler may control one or more attack agents 20A-20N. The arrangement shown for executing a computer system compromise is illustrative only and may compromise numerous arrangements that are as simple as a single attack machine 10 attacking a target machine 30 by, for example, sending malicious probe packets or other data intended to compromise target machine 30. Target machine may be, and often is, connected to a larger network and access thereto by attack machine 10 may cause damage to a large collection of computer systems commonly located within the network.

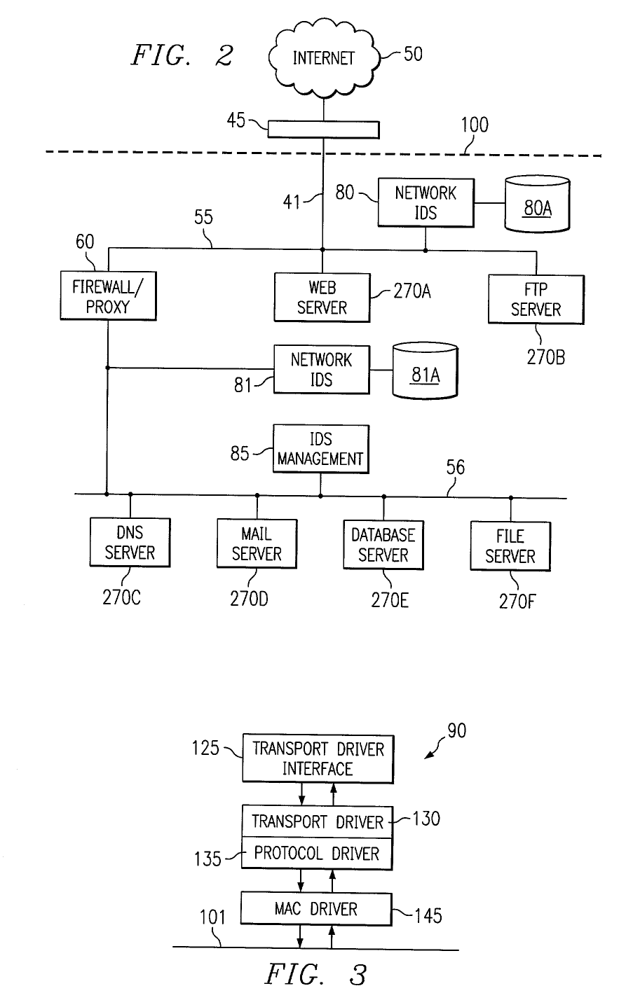

In FIG. 2, there is illustrated a comprehensive intrusion prevention system employing network-based and hybrid host-based/node-based intrusion detection technologies according to an embodiment of the invention. One or more networks 100 may interface with the Internet 50 via a router 45 or other device. In the illustrative example, two Ethernet networks 55 and 56 are comprised in network 100. Ethernet network 55 comprises a web-content server 270A and a file transport protocol-content server 270B. Ethernet network 56 comprises a domain name server 270C, a mail server 270D, a database sever 270E and a file server 270F. A firewall/proxy router 60 disposed intermediate Ethernets 55 and 56 provides security and address resolution to the various systems of network 56. A network-based IPS appliance 80 and 81 is respectively implemented on both sides of firewall/proxy router 60 to facilitate monitoring of attempted attacks against one or more elements of Ethernets 55 and 56 and to facilitate recording successful attacks that successfully penetrate firewall/proxy router 60. Network-based IPS appliances 80 and 81 may respectively comprise (or alternatively be connected to) a database 80A and 81A of known attack signatures, or rules, against which network frames captured thereby may be compared. Alternatively, a single database (not shown) may be centrally located within network 100 and may be accessed by network-based IPS appliances 80 and 81. Accordingly, network-based IPS appliance 80 may monitor all packets inbound from Internet 50 to network 100 arriving at Ethernet network 55. Similarly, a network-based IPS appliance 81 may monitor and compare all packets passed by firewall/proxy router 60 for delivery to Ethernet network 56. An IPS management node 85 may also be part of network 100 to facilitate configuration and management of the IPS components in network 100.

In view of the above-noted deficiencies of network-based intrusion prevention systems, a hybrid host-based and node-based intrusion prevention system is preferably implemented within each of the various nodes, such as servers 270A-270N (also referred to herein as “nodes”), of Ethernet networks 55 and 56 in the secured network 100. Management node 85 may receive alerts from respective nodes within network 100 upon detection of an intrusion event by any one of the network-based IPS appliances 80 and 81 as well as any of the nodes of network 100 having a hybrid agent-based and node-based IPS implemented thereon. Additionally, each node 270A-270F may respectively employ a local file system for archiving intrusion-related events, generating intrusion-related reports, and storing signature files against which local network frames and/or packets are examined.

Preferably, network-based IPS appliances 80 and 81 are dedicated entities for monitoring network traffic on associated Ethernets 55 and 56 of network 100. To facilitate intrusion detection in high speed networks, network-based IPS appliances 80 and 81 preferably comprise a large capture RAM for capturing packets as they arrive on respective Ethernet networks 55 and 56. Additionally, it is preferable that network-based IPS appliances 80 and 81 respectively comprise hardware-based filters for filtering network traffic, although IPS filtering by network-based IPS appliances 80 and 81 may be implemented in software. Moreover, network-based IPS appliances 80 and 81 may be configured, for example by demand of IPS management node 85, to monitor one or more specific devices rather than all devices on a common network. For example, network-based IPS appliance 80 may be directed to monitor only network data traffic addressed to web server 270A.

Hybrid host-based/node-based intrusion prevention system technologies may be implemented on all nodes 270A-270N on Ethernet networks 55 and 56 that may be targeted by a network attack. In general, each node is comprised of a reprogrammable computer having a central processing unit (CPU), a memory module operable to store machine-readable code that is retrievable and executable by the CPU, and may further comprise various peripheral devices, such as a display monitor, a keyboard, a mouse or another device, connected thereto. A storage media, such as a magnetic disc, an optical disc or another component operable to store data, may be connected to memory module and accessible thereby and may provide one or more databases for archiving local intrusion events and intrusion event reports. An operating system may be loaded into memory module, for example upon bootup of the respective node, and comprises an instance of a protocol stack as well as various low-level software modules required for tasks such as interfacing to peripheral hardware, scheduling of tasks, allocation of storage as well as other system tasks. Each node protected by the hybrid host-based and node-based IPS of the present invention accordingly has an IPS software application maintained within the node, such as in a magnetic hard disc, that is retrievable by the operating system and executable by the central processing unit. Additionally, each node executing an instance of the IPS application has a local database from which signature descriptions of documented attacks may be fetched from storage and compared with a packet or frame of data to detect a correspondence therebetween. Detection of a correspondence between a packet or frame at an IDS server may result in execution of any one or more of various security procedures.

The IPS described with reference to FIG. 2 may be implemented on any number of platforms. Each hybrid host-based/node-based instance of the IPS application described herein is preferably implemented on a network node, such as web server 270A operated under control of an operating system, such as Windows NT 4.0 that is stored in a main memory and running on a central processing unit, and attempts to detect attacks targeted at the hosting node. The particular network 100 illustrated in FIG. 2 is exemplary only and may comprise any number of network servers. Corporate, and other large scale, networks may typically comprise numerous individual systems providing similar services. For example, a corporate network may comprise hundreds of individual web servers, mail servers, FTP servers and other systems providing common data services.

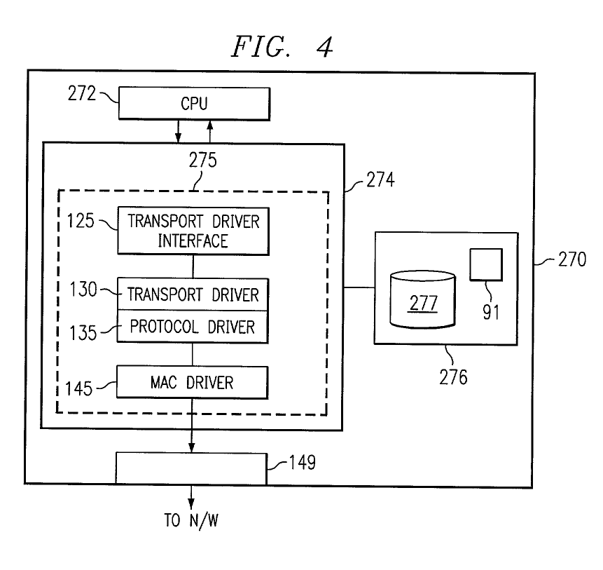

Each operating system of a node incorporating an instance of an IPS application additionally comprises a network protocol stack 90, as illustrated in FIG. 3, that defines the entry point for frames received by a targeted node from the network, e.g. the Internet or Intranet. Network stack 90 as illustrated is representative of the well-known WindowsNT (TM) system network protocol stack and is so chosen to facilitate discussion and understanding of the invention. However, it should be understood that the invention is not limited to a specific implementation of the illustrated network stack 90 but, rather, stack 90 is described to facilitate understanding of the invention. Network stack 90 comprises a transport driver interface (TDI) 125, a transport driver 130, a protocol driver 135 and a media access control (MAC) driver 145 that interfaces with the physical media 101. Transport driver interface 125 functions to interface the transport driver 130 with higher-level file system drivers. Accordingly, TDI 125 enables operating system drivers, such as network redirectors, to activate a session, or bind, with the appropriate protocol driver 135. Accordingly, a redirector can access the appropriate protocol, for example UDP, TCP, NetBEUI or other network or transport layer protocol, thereby making the redirector protocol-independent. The protocol driver 135 creates data packets that are sent from the computer hosting the network protocol stack 90 to another computer or device on the network or another network via the physical media 101. Typical protocols supported by an NT network protocol stack comprise NetBEUI, TCP/IP, NWLink, Data Link Control (DLC) and AppleTalk although other transport and/or network protocols may be comprised. MAC driver 145, for example an Ethernet driver, a token ring driver or other networking driver, provides appropriate formatting and interfacing with the physical media 101 such as a coaxial cable or another transmission medium.

The capabilities of the host-based IPS comprise application monitoring of: file system events; registry access; successful security events; failed security events and suspicious process monitoring. Network access applications, such as Microsoft IIS and SQL Server, may also have processes related thereto monitored.

Intrusions may be prevented on a particular IPS host by implementation of inline, node-based monitoring technologies. The inline-IPS is preferably comprised as part of a hybrid host-based/node-based IPS although it may be implemented independently of any host-based IPS system. The inline-IPS will analyze packets received at the hosting node and perform signature analysis thereof against a database of known signatures by network layer filtering.

In FIG. 4, there is illustrated a network node 270 that may run an instance of an IPS application 91 and thus operate as an IPS server. IPS application 91 may be implemented as a three-layered IPS, as described in co-pending application entitled “Method and Computer Readable Medium for a Three-Layered Intrusion Prevention System for Detecting Network Exploits” and filed concurrently herewith, and may comprise a server application and/or a client application. Network node 270, in general, comprises a central processing unit (CPU) 272 and a memory module 274 operable to store machine-readable code that is retrievable and executable by CPU 272 via a bus (not shown). A storage media 276, such as a magnetic disc, an optical disc or another component operable to store data, may be connected to memory module 274 and accessible thereby by the bus as well. An operating system 275 may be loaded into memory module 274, for example upon bootup of node 270, and comprises an instance of protocol stack 90 and may have an intrusion prevention system application 91 loaded from storage media 276. One or more network exploit rules, an exemplary form described in co-pending application entitled “Method, Node and Computer Readable Medium for Identifying Data in a Network Exploit” and filed concurrently herewith, may be compiled into a machine-readable signature(s) and stored within a database 277 that is loadable into memory module 274 and may be retrieved by IPS application 91 for facilitating analysis of network frames and/or packets.

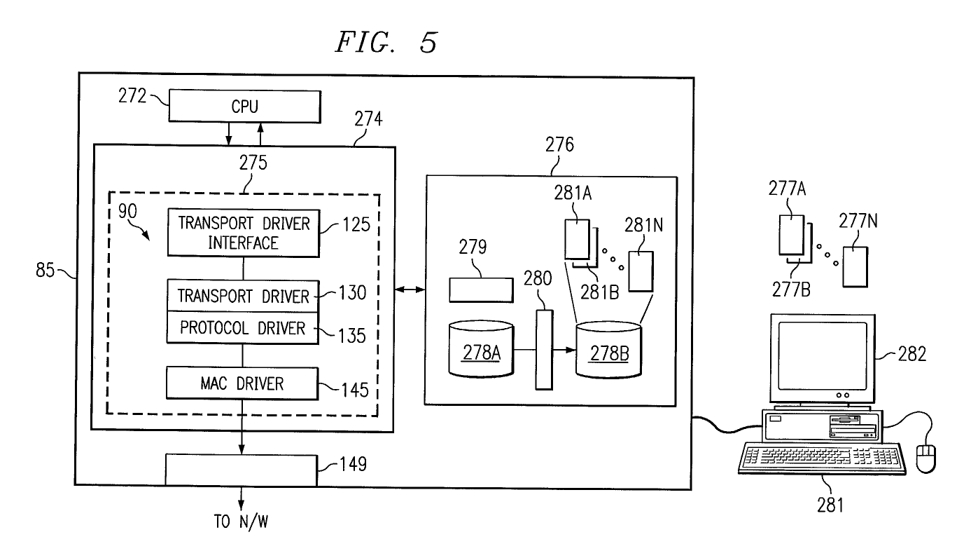

In FIG. 5, there is illustrated an exemplary network node that may operate as a management node 85 of the IPS of a network 100. Management node 85, in general, comprises a CPU 272 and a memory module 274 operable to store machine-readable code that is retrievable and executable by CPU 272 via a bus (not shown). A storage media 276, such as a magnetic disc, an optical disc or another component operable to store data, may be connected to memory module 274 and accessible thereby by the bus as well. An operating system 275 may be loaded into memory module 274, for example upon bootup of node 85, and comprises an instance of protocol stack 90. Operating system 275 is operable to fetch an IPS management application 279 from storage media 276 and load management application 279 into memory module 274 where it may be executed by CPU 272. Node 85 preferably has an input device 281, such as a keyboard, and an output device 282, such as a monitor, connected thereto.

An operator of management node 85 may input one or more text-files 277A-277N via input device 281. Each text-file 277A-277N may define a network-based exploit and comprise a logical description of an attack signature as well as IPS directives to execute upon an IPS evaluation of an intrusion-related event associated with the described attack signature. Each text file 277A-277N may be stored in a database 278A on storage media 276 and compiled by a compiler 280 into a respective machine-readable signature file 281A-281N that is stored in a database 278B. Each of the machine-readable signature files 281A-281N comprises binary logic representative of the attack signature as described in the respectively associated text-file 277A-277N. An operator of management node 85 may periodically direct management node 85, through interaction with a client application of IPS application 279 via input device 281, to transmit one or more machine-readable signature files (also generally referred to herein as “signature files”) stored in database 278B to a node, or a plurality of nodes, in network 100. Alternatively, signature files 281A-281N may be stored on a computer-readable medium, such as a compact disk, magnetic floppy disk or another portable storage device, and installed on node 270 of network 100. Application 279 is preferably operable to transmit all such signature-files 281A-281N, or one or more subsets thereof, to a node, or a plurality of nodes, in network 100. Preferably, IPS application 279 provides a graphical user interface on output device 282 for facilitating input of commands thereto by an operator of node 85.

As mentioned hereinabove, attack signatures are preferably described in respective text files that may be stored in a database 278A and each text file be converted to a machine-readable signature file 281A by compiler 289. As aforementioned, compiler 289 is executable by CPU 272 and is operable to convert the text-based description of an attack signature defined in a text-file 281A stored in database 278A into a machine code, stored in a respective signature file 281A, that is stored in database 278B and that is readable by a computer and suitable for comparison against network frames and/or packets. Signature files 281A-281N stored in database 278B may then be transmitted to a node, such as node 270 illustrated in FIG. 4, of network 100, stored in a local database 277 and fed to respective IPS application 91 that may be installed in network stack 90. Additionally, each text file preferably defines directives to be executed by IPS application 91 upon detection of a packet corresponding to signature file. Thus, a machine-readable signature file preferably includes binary logic that directs IPS application 91 to perform the directives specified in the text-file from which the signature file originates. An associative process engine of IPS application 91 may then inspect network traffic by interrogation of local signature file database 277. Machine-readable signature files stored in database 277 also preferably define one or more actions to be performed upon identification of a correspondence between a respective signature file and a network frame or packet, for example the signature file may contain binary logic that specifies discarding the network frame, reporting the occurrence to a management node, archiving of the identified frame or execution of another security action.

An associative process engine and an event processor of IPS application 91 are configured to ensure that all matching signatures are identified, i.e., processing of signatures against a packet is not halted upon confirmation of a single match according to an embodiment of the invention. Rather, all enabled signatures are compared against a given packet and an event processor may log the plurality of signature matches in an event database thereby providing evidence of multiple positive identifications between a network frame or packet and multiple signature files stored in database 277. Thus any event notification may reference one or more matching signature files and thus multiple intrusion events are reported in a single event reported by an intrusion event manager of IPS application 91.

TABLE A shows two exemplary text-based network-exploit rules providing text-based signature descriptions, for example in text file 277A supplied to management node 85 by an operator thereof and from which the machine-readable signature file 281A may be generated from compilation thereof by compiler 289. Machine-readable signature file 281A may then be fed into network stack 90 of operating system 275 running on node 270 upon supply of the machine-readable signature file 281A to node 270.

TABLE A
BEGIN_SECURITY_DEF: SFDefendICMPFrag

PLATFORM:AGENT_AND_APPLIANCE
ENABLED:1
BRIEF_DESCRIPTION: “Detect ICMP Fragmentation’
EXPLANATION: ‘ICMP Fragmentation is network mapping or an exploit using

ICMP fragmentation to elude an IPS or firewall. ICMP packets normally are not
fragmented.’

SEVERITY:3
MANUAL_FIX_DESCRIPTION: ‘Enable the Prevent option in your policy

settings.’

GENERAL_RESULTS_TEXT: ‘ICMP Fragmentation: %s’
DETAILED_DISPLAY_OPTION: OPTIMIZED

.
.
.

BEGIN_POLICY_DEF: Prevent

PLATFORM: AGENT_AND_APPLIANCE
BRIEF_DESCRIPTION: ‘Prevent ICMP Fragmentation’
EXPLANATION: ‘Yes = Prevent; No = Do Not Prevent’
TYPE: DROPLIST
DEFAULT_VALUE:’Yes’
LIST:”Yes;No’

END_POLICY_DEF
BEGIN_SIGNATURE_DEF

if ((icmp) &&

(ip[6:1] & 0x20) //Fragment Flag set
&&
(

(ip[6:2]&0x1fff)=0 //Initial Fragment (Offset = 0)

)
)
then

ACTION: LOG_FRAME
DIRECTION: OUTBOUND|INBOUND

endif

END_SIGNATURE_DEF
END_SECURITY_DEF
BEGIN_SECURITY_DEF: SFDefendICMPRisk

PLATFORM:AGENT_AND_APPLIANCE
ENABLED:0
BRIEF_DESCRIPTION: ‘Detect ICMP Scan’
EXPLANATION: ‘An ICMP Scan is network mapping using ICMP, which is

typically accomplished using traceroute, ping, fping, gping or nmap. This rule should
only be implemented at the firewall’

SEVERITY:3
MANUAL_FIX_DESCRIPTION: ‘Enable the Prevent option in your policy

settings.’

GENERAL_RESULTS_TEXT: ‘ICMP Scan: %s’
DETAILED_DISPLAY_OPTION: OPTIMIZED
.
.
.

BEGIN_POLICY_DEF: Prevent
PLATFORM: AGENT_AND_APPLIANCE
BRIEF_DESCRIPTION: ‘Prevent ICMP Scan’
EXPLANATION: “Yes = Prevent; No = Do Not Prevent’
TYPE:DROPLIST
DEFAULT_VALUE: ‘No’
LIST: ‘Yes;No’
END_POLICY_DEF
BEGIN_SIGNATURE_DEF
//Inbound signature definition
//May only want to implement this rule at firewall
//Disallows: Source Quench, Redirect, Echo Request
// Parameter Problem, Timestamp Request
// Info Req/Reply, Mask Req/Reply

if ((icmp) &&

(icmp[0:1]!=0x0) && //Echo Reply
(icmp[0:1]!=0x3) && //Destination Unreachable
(icmp[0:1]!=0x11) && //Time Exceeded
(icmp[0:1]!=0x14) && //TimeStamp Reply
)

then

ACTION:LOG_FRAME
DIRECTION:INBOUND

endif

//Outbound signature definition
//May only want to implement this rule at firewall
//Disable destination unreachable messages, as any information feedback gives
//the attacker information

if ((icmp) && (icmp[0:1] = 0x3) && //Destination Unreachable

(

(icmp[1:1]=0) ∥ //Net Unreachable
(icmp[1:1]=1) ∥ //Host Unreachable
(icmp[1:1]=2) ∥ //protocol unreachable
(icmp[1:1]=3) ∥ //Port Unreachable
(icmp[1:1]=4) ∥ //Fragmentation needed
(icmp[1:1]=5) ∥ //source route failed
(icmp[1:1]=9) ∥ //dst network Admin prohibited
(icmp[1:1]=10) ∥ //dst host admin prohibited
(icmp[1:1]=13) ∥ //communication admin prohibited by filtering

)

)

then

ACTION:LOG_FRAME
DIRECTION:OUTBOUND

endif

END_SIGNATURE_DEF
END_SECURITY_DEF
Note:
IP header specifications provided in Appendix

The first exemplary signature description provided in TABLE A describes Internet control message protocol (ICMP) fragmentation that may be utilized by an attacker to elude an IPS or firewall. Legitimate, non-hostile ICMP fragments are not typically encountered and thus IPS application 91 may scan for ICMP fragmentation and execute security measures or alerts upon identification thereof. Accordingly, the signature description for ICMP fragmentation first requires identification that an analyzed packet is in fact an ICMP packet. The ICMP packet condition is logically ANDed with the following logical conditions:

1) (ip[6:1] & 0×20)

2) (ip[6:2]&0×1fff)=0

which are themselves logically ANDed. Statement 1) directs IPS application 91 to read byte 6 of the IP header and perform a bitwise AND with 20₁₆ thus checking the IP header for an asserted fragment flag. Statement 2) directs IPS application 91 to read bytes 6 and 7 of the IP header and, by bitwise ANDing with 1fff₁₆, to determine whether the 13-bit fragment offset is zero—a logical FALSE evaluation thus indicating that the scanned packet is the first packet of a fragmented ICMP datagram. An affirmative evaluation of the if condition therefore indicates that the scanned packet is indeed a fragmented ICMP packet. One or more directives associated with the signature may then be executed. In the exemplary signature description, the defined directive specifies logging of the frame whether it is inbound or outbound.

The second exemplary signature description describes an exploit referred to as an ICMP scan. An ICMP scan is a network mapping that uses ICMP and is commonly utilized by well-known utilities such as traceroute, ping, fping, gping or nmap. These utilities may provide legitimate, useful services when performed by, for example, an authorized network administrator or other person within network 100. Thus, it may be desirable to implement an analysis of such a signature within and IPS application 91 solely at a firewall to detect the attempted usage thereof from external sources.

The exemplary ICMP scan signature description includes an inbound and an outbound signature description. An inbound packet received by IPS application 91 may be classified as suspect when the ICMP message type, as specified by the ICMP type field, is not a type that would typically be transmitted to the protected network from an external network as a legitimate ICMP message. The exemplary ICMP scan signature description will cause a positive evaluation of a suspect packet upon evaluation that:

1) the packet is confirmed to be an ICMP packet; and

2) the ICMP packet is not one of:

a) an echo reply;

b) a destination unreachable ICMP message;

c) a time exceeded ICMP message;

d) a timestamp reply message.

Accordingly, any ICMP source quench messages (type 4), redirect message (type 5), echo request message (type 8), router advertisement (type 9), router solicitation (type 10), parameter problem (type 12), timestamp request (type 13), timestamp reply (type 14), as well as address request and address mask reply messages (types 17 and 18) received inbound are typically indicative of network scan utilities that obtain network information from the response to these ICMP messages. The signature description above allows positive identification of an exploit event upon evaluation of any of these ICMP types and results in invocation of an inbound signature directive—specifically, logging of the inbound frame.

Additionally, an ICMP outbound signature description is included in the exemplary ICMP scan signature description and provides a positive identification of an exploit event for various type 3 ICMP messages to facilitate suppression of a response by the protected network. Attackers may glean useful network information based upon the various ICMP destination unreachable error messages (type 3). Accordingly, an outbound ICMP packet scan is performed that scans for any type 3 ICMP packet having any one of code field values 0-5, 9, 10, or 13 and results in a positive identification of an exploit and invocation of the outbound signature directive of logging of the outbound frame.

As mentioned above, a skilled attacker may advantageously exploit knowledge of the IPS and the precedence and/or priority assigned to the signature scans in order to circumvent security measures of IPS application 91. For example, if an ICMP packet is first scanned for the ICMP fragmentation signature prior to scanning for the ICMP scan signature, prior art IPS applications would have no knowledge that an ICMP scan exploit had been performed if the ICMP fragmentation signature scan results in a positive evaluation thereof. As shown by the ICMP fragmentation and ICMP scan signatures, an exploit may involve both ICMP fragmentation and the more general ICMP scan. Techniques may be devised to bypass an IPS based on the fact that common IPS applications abort signature scanning upon a first positive evaluation of a signature match. The present invention preferably requires all enabled signatures, or subsets thereof, to be scanned, regardless of the number of positive evaluations of attack signatures. Accordingly, one or more positive evaluations may be reported in any given event reports to a management console of the present invention. Accordingly, all security directives in each signature description having a correspondence with a given network frame or packet may be executed by IPS 91. Additionally, an alternative security directive may be determined and executed dependent upon the distinct combination of signature descriptions that are determined to have a correspondence with a network frame or packet.

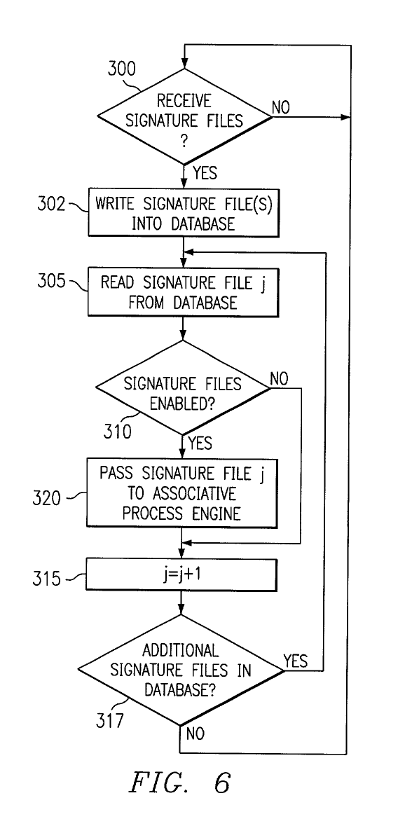

With reference to FIG. 6, there is shown a flowchart of IPS application 91 processing according to an embodiment of the present invention. One or more signature files may be received by IPS application 91 (step 300) and thereafter written into database 277 (302). Signature files may be received locally, such as from floppy disk, compact disc or other digital media, or remotely, such as via a communication session with management node 85. An application layer of IPS application 91 then reads a signature file (Signature Fileⱼ) from database 277 (step 305) and evaluates the Signature Fileⱼ to determine if it is enabled (step 310). Signature files in database 277 may be indexed such that simply incrementing a counter variable (j) (step 315) allows incrementing through the available signature files in database 277. Determination that Signature Fileⱼ is disabled results in IPS processing performing an increment of counter variable j and evaluating whether an additional Signature Fileⱼ is available to be read from database 277 (step 317). EPS processing reads the next Signature Fileⱼ (step 305) upon confirmation that an additional Signature Fileⱼ is available to be read therefrom or, alternatively, IPS processing returns to polling for reception of new signature files (step 300) is there are no additional Signature Filesⱼ to be read from the database. Upon confirmation that Signature Fileⱼ is enabled, Signature Fileⱼ may be passed to an associative process engine for processing by an inline IPS module (step 320) where the signature files determined to be enabled by the described IPS processing may be installed for interrogation by an associative process engine of a network filter service provider.

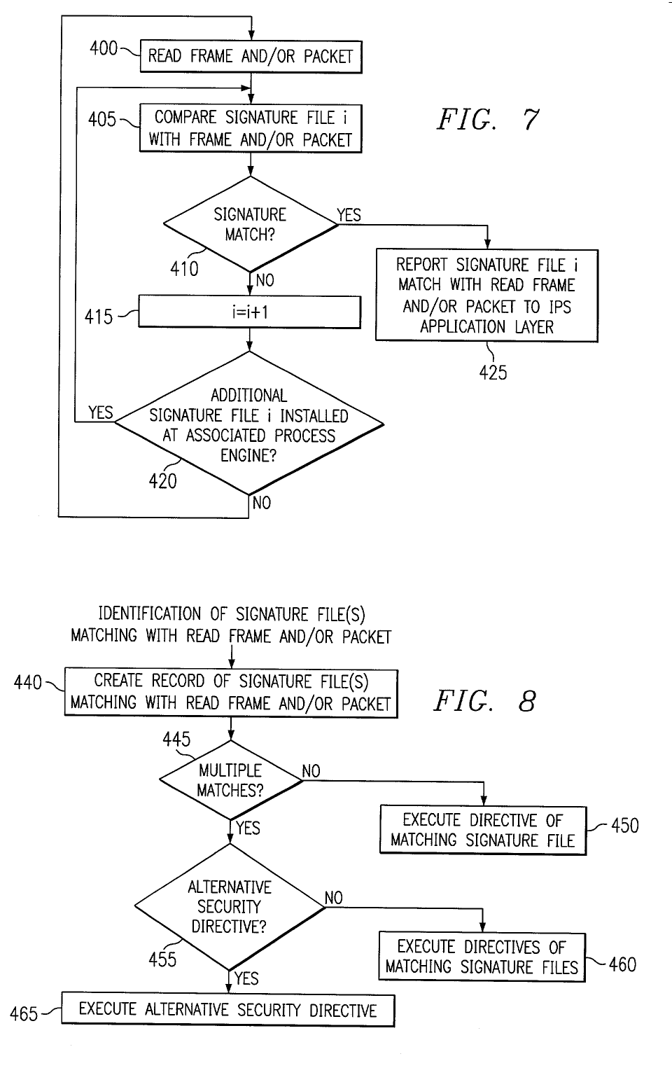

With reference to FIG. 7, there is shown a flowchart of an IPS application 91 processing procedure that may be performed by an associative process engine of a network filter service provider of IPS application 91 that provides reporting of multiple signature matches according to an embodiment of the invention. IPS application 91 allows for multiple or alternative execution of signature directives upon matching of multiple machine-readable signature files with a single frame and/or packet. A frame and/or packet is first read, for example by an inline module of IPS 91 (step 400). The associative process engine compares Signature Fileᵢ (step 405) with the read frame and/or packet to determine if a correspondence, or signature match, exists therebetween (step 410), whereupon a record of the match is denoted by a module of IPS application 91 (step 425). The record denoting all signature file matches obtained by the application layer of IPS application 91 may, accordingly, record multiple signature file matches made between a single frame and/or packet and more than one signature files. Failure to determine a correspondence between Signature File, and the read frame and/or packet results in IPS processing performing an increment of a counter variable i (step 415) and determining if an additional Signature Fileᵢ is installed at the associative process engine (step 420). Confirmation of availability of additional signature files results in comparison of Signature Fileᵢ with the read frame and/or packet (step 405). IPS processing returns to await for the next frame and/or packet (step 400) upon determining that no additional Signature Filesᵢ are available for comparison with the currently read frame and/or packet.

With reference to FIG. 8, there is shown a flowchart of IPS processing performed at the application layer in response to reception or a report thereby of signature matches, as determined and reported according to IPS processes described with reference to FIGS. 6 and 7. Upon receiving a report of a signature file(s) match with a read frame and/or packet, a record, or log, of the match may be generated by a module of IPS application 91 (step 440). The record denoting all signature file matches obtained by the application layer of IPS application 91 may, accordingly, record multiple signature file matches made between a single frame and/or packet and more than one signature files.

IPS application 91 may evaluate the record of matches to determine if multiple signature files have a correspondence with a given frame and/or packet (step 445). If only a single signature file is determined to have a correspondence with a given frame and/or packet, the directive of the signature file may then be executed by IPS application 91 (step 450). If, however, multiple signature files are determined to have a correspondence with a frame and/or packet, IPS application 91 may determine whether an alternative directive specific to the combination of matching signature files exists (step 455). An alternative security directive may be specified by machine-readable logic of one or more matching signature files or an alternative security directive may be obtained, for example, through interrogation of database 277 with identifiers, such as unique index numbers, of the matching signature files. Upon confirmation that an alternative security directive exists for the matching signature files, IPS application 91 may direct execution of the alternative security directive (step 465). Alternatively, an alternative security directive may not exist when multiple matching signature files are determined for a frame and/or packet and, accordingly, IPS application 91 may direct execution of each security directive of each machine-readable signature file determined to have a correspondence with the frame and/or packet (step 460).

At times, directives of matching signature files may conflict with one another. For example, a directive of a signature file may specify dropping of the matching frame and/or packet while a directive of another matching signature file may specify that the IPS allow the frame and/or packet to pass. In such a case, resolution of the conflict may be achieved by including a priority, such as a severity field having a numerical value assigned thereto, within each signature file that provides precedence amongst various signature files. Alternatively, specific actions of directives may have priorities assigned thereto. For example, a “Drop Packet” action included in a directive may take precedence over other actions, such as “Pass Packet,” in which case the higher priority action, in this case “Drop Packet,” is executed. Other remedies of conflicting directives may be possible.

The text-based signatures described in TABLE A are illustrative only and are chosen to facilitate an understanding of the invention. Numerous signature descriptions may be defined and have signature files generated therefrom that may have a correspondence with a given network frame or packet and may appropriately be identified by the multiple-signature matching technique of the present invention.

[image]

What is claimed:

1. A node of a network maintaining an instance of an intrusion prevention system, the node comprising:
a memory module for storing data in machine-readable format for retrieval and execution by a central processing unit; and
an operating system comprising a network stack comprising a protocol driver, a media access control driver and an instance of the intrusion prevention system implemented as an intermediate driver and bound to the protocol driver and the media access control driver, the intrusion prevention system comprising an associative process engine and an input/output control layer, the input/output control layer operable to receive at least one of a plurality of machine-readable network-exploit signatures from a database and provide the at least one machine-readable network-exploit signatures to the associative process engine, the associative process engine operable to compare a packet with the at least one machine-readable network-exploit signature and determine a correspondence between the packet and the at least one machine-readable network-exploit signature.

2. The node according to claim 1, wherein the database is maintained in a storage device of the node.

3. The node according to claim 1, wherein each of the plurality of machine-readable network-exploit signatures comprise a respective directive that defines instructions to be executed upon determination of a correspondence between the packet and the respective exploit signature.

4. The node according to claim 1, wherein, upon determination of a correspondence between the packet and two or more of the plurality of machine-readable network-exploit signatures, each of the directives of the two or more machine-readable network-exploit signatures are executed by the intrusion prevention system.

5. The node according to claim 1, wherein, upon determination of a correspondence between the packet and two or more of the plurality of machine-readable network-exploit signatures, an alternative directive is executed, the alternative directive dependent upon the combination of the two or more network-exploits signatures having a correspondence with the packet.

6. A method of analyzing a packet at a node of a network by an intrusion prevention system executed by the node, comprising:
reading the packet by the intrusion prevention system;
comparing the packet with a plurality of machine-readable network-exploit signatures; and
determining a correspondence between the packet and at least two of the plurality of machine-readable network-exploit signatures.

7. The method according to claim 6, further comprising generating a record of the at least two of the plurality of machine-readable network-exploit signatures with which a correspondence with the packet is made.

8. The method according to claim 7, further comprising transmitting the record to a management node connected to the network.

9. The method according to claim 7, further comprising logging the record in a database.

10. The method according to claim 6, further comprising executing, by the intrusion protection system, a respective directive of each of the at least two machine- readable signatures determined to correspond with the packet.

11. The method according to claim 6, further comprising executing, by the intrusion protection system, at least one directive of at least one of the machine- readable network-exploit signatures of the record determined to have a correspondence with the packet.

12. The method according to claim 6, further comprising executing, by the intrusion protection system, an alternative directive dependent on the record of machine-readable signatures determined to have a correspondence with the packet.

13. A computer-readable medium having stored thereon a set of instructions to be executed, the set of instructions, when executed by a processor, cause the processor to perform a computer method of:
comparing a packet with a plurality of machine-readable network-exploit signatures;
determining a correspondence between the packet and at least a subset of the plurality of machine-readable network-exploit signatures; and
generating a record of the subset with which the correspondence is made.

14. The computer readable medium according to claim 13, further comprising a set of instructions that cause, when executed by the processor, the processor to perform a computer method of:
determining a correspondence between the packet and a subset of the plurality of machine-readable network-exploit signatures, each machine-readable network-exploit signature comprising a directive; and
executing, by the processor, each directive of the record of machine-readable signatures.

15. The computer readable medium according to claim 13, further comprising a set of instructions that cause, when executed by the processor, the processor to perform a computer method of
executing a directive dependent on the machine-readable network-exploit signatures within the subset.
